(19) United States
(12) Patent Application Publication
(10) Pub. No.: US 2006/0012977 A1
(43) Pub. Date: Jan. 19, 2006

(54) SLATWALL LIGHTING SYSTEM

(75) Inventor: Mark Joseph, Aspen, CO (US)

Correspondence Address: GLENN L. WEBB, P.O BOX 951, CONIFER, CO, 80433, US

(73) Assignee: LITESNOW LLC, Aspen, CO (US)

(21) Appl. No.: 10/710,351

(22) Filed: Jul. 2, 2004

(51) Int. Cl. F21S 8/00

(52) U.S. Cl. 362/147

(57) ABSTRACT

An attachment device that allows a user to quickly and easily assemble a lighting system on a slotted or grooved room surface such as a slatwall. The system provides an elongated member that provide both power and support to a plurality of lighting fixtures, which may attached to slots or grooves on a room surface. The lighting fixtures are removably attachable to the elongated member and do not require independent wiring or power sources. The lighting fixtures themselves are able to slide along the elongated member while under power and allow rotation for positioning the direction of their illumination.

### BACKGROUND OF INVENTION

The typical lighting in many homes, offices, workshops and retail displays are typically either fluorescent or lamp mounted incandescent lighting. These types of lighting lack flexibility in providing the appropriate positioning for lighting the surrounding spacing, particularly if the space is frequently reconfigured. Further, these types of lighting are often utilitarian in nature and lack decorative appeal. One attempt at solving these problems has been to use track lighting.

Systems for decorative or utility lighting are commonly suspended from a room surface, either by attaching the lighting fixtures to a frame or grid or by permanently attaching the fixtures to the ceiling or walls of the room near where the desired illumination is to be focused. More recently, systems have been developed in Europe that allow both power and support of the lighting system to be accomplished simultaneously. These systems have become popular both for their simplicity and their functionality, because they allow a user to set up a lighting system with few components and modify that system on demand. Such systems have also become commonplace in the United States and other countries for both utility and decorative lighting.

Most of theses systems are mounted to a surface that requires significant modification to provide the power necessary to illuminate a number of lamps. One of these systems is disclosed in U.S. Pat. No. 4,747,025, which employs a custom-built slatwall to provide simultaneous power and support to each lamp. The obvious disadvantage of this system is that the user must wire each possible lamp location independently. Another disadvantage of this system is the presence of an exterior cable between the fixture and the mounting apparatus. Due to these disadvantages, significant time must be spent configuring the lighting system each time a system is installed or modified.

Another disadvantage of the system disclosed in U.S. Pat. No. 4,747,025 is that it requires attachment to multiple slots on the slatwall. This limits the location of lighting fixtures adjacent to one another, and requires careful alignment of the lighting fixture with the appropriate leads. It also requires a custom-sized mounting mechanism for each lamp.

Other systems have tried to overcome these disadvantages by providing power to the lamp from a more remote source. One such system is disclosed in U.S. Pat. No. 6,199,705. This system, however, still requires that the user modify the existing surface. Specifically, the surface requires electrical outlets placed continuously along one side of the room surface. In addition, the user will be required to modify the lengths of the wiring whenever relocation of the lighting fixtures is desired.

Another such system is disclosed in U.S. Pat. No. 5,816,696. This system uses a pegboard surface with battery or electric power source coupled to the base of a hook to provide illumination at its opposite end. The disadvantages of this system include the presence of an integrated power source coupled to each lamp, as well as the need to adjust their position based off the wiring requirements. This system also includes the limited ability to alter the direction or illumination of the lamps once suspended from the pegboard surface.

Another disadvantage of the prior art is the complexity of the hardware required for installation. One such system is disclosed in U.S. Pat. No. 5,142,460. This system requires multiple points of mounting on both the horizontal and vertical room surfaces. This system also limits the flexibility of the lighting system arrangement by imposing a rigid supporting method and pre-configured lamp locations. In order to ensure that all relevant electrical codes have been met, a user will typically have to employ a professional electrician to rewire and mount the individual lighting fixtures.

It is therefore an object of the present invention to provide a lighting system that provides both power and support in a combined attachment device mountable to a common room surface, allowing quick and easy installation and manipulation. It is also an object of the present invention to provide the user with increased flexibility to modify the position of the lighting fixtures and the direction of the illumination of those lighting fixtures.

### SUMMARY OF INVENTION

The present invention solves these problems and others by providing a unique lighting system with a simple and effective attachment device. The attachment device provides the flexibility and decorative appeal of a track lighting system with the utility and flexibility of a slatwall system.

In a preferred embodiment of the invention the attachment device includes an elongated rail or track. The track, in a preferred embodiment, has a continuous C-channel. The track includes a tongue element that allows it to be attached to a slotted or grooved room surface, such as a slatwall system, through engagement of a slot with the tongue element. The rail may comprise part or all of the attachment element and also may be removable from the elongated track. The tongue element is sized to slide easily into the slot or groove, yet retain securely against the room surface.

A lighting fixture, such as a typical track lighting fixture, with an attachment base shaped to engage with the C-channel may be attached at any location on the elongated member. In this preferred embodiment, multiple C-channel members may be mounted to several slots or grooves present on the room surface, such as slatwall, and thereby allowing multiple lamps to be hung at a variety of locations. Although a slotted surface such as slatwall is the example provided in this preferred embodiment, it is to be expressly understood that other types of grooved, notched, slotted or other similar ways of providing an aperture on the room surface are considered to be embodied by the invention.

Power is provided to the lighting fixture through a pair of conductors that run along the interior of the C-channel and connect with contacts located on the base of the lighting fixture when engaged with the elongated member. These conductors are open-air conductors but are positioned to be finger safe.

In an alternate embodiment, the attachment device has a substantially flat mounting surface opposite the tongue element. This allows mounting of any track for use with track lighting to mounted onto the mounting surface. Other shapes not specifically mentioned in this description are considered to be within the scope of the claimed invention.

In another preferred embodiment, the attachment device includes a low profile track. The track has a relatively smooth outer exposed surface. On the opposing surface, a tongue element is provided that fits into a slot on a slatwall system. Conductor elements are secured on the rear opposing side as well spaced from on another. These conductor elements are attached to a power supply for supplying electrical current. Light fixtures engage over the exposed surface to come into contact with the conductor elements to supply electrical power to the light fixtures.

These and other features of the present invention are evident from the drawings along with the detailed description of preferred embodiments. (For a fuller understanding of the nature and advantages of the invention, reference should be made to the ensuing detailed description taken in conjunction with the accompanying drawings.)

### BRIEF DESCRIPTION OF DRAWINGS

FIG. 1 is a perspective view of the system described in the preferred embodiment.

FIG. 2 is a perspective view of a typical slatwall system.

FIG. 3 is a perspective view of an office slatwall system.

FIG. 4 is a cross-sectional view of the office slatwall system of FIG. 4.

FIG. 5 is a cross-sectional view of the system of the embodiment in FIG. 1.

FIG. 6 is a cross-sectional view of another embodiment of the present invention.

FIG. 7 is a perspective view of the system of FIG. 6.

FIG. 8 is a perspective view of the system of FIG. 7.

### DETAILED DESCRIPTION

The present invention provides systems for providing modular lighting for a variety of applications. It is to be expressly understood that this exemplary embodiment is provided for descriptive purposes only and is not meant to unduly limit the scope of the present inventive concept. Other embodiments and variations of the conductors or lighting fixtures of the present invention are considered within the present inventive concept as set forth in the claims herein. For explanatory purposes only, the lighting apparatus of the preferred embodiments are discussed primarily for the purposes of understanding the method of installation. It is to be expressly understood that other devices are contemplated for use with the present invention as well.

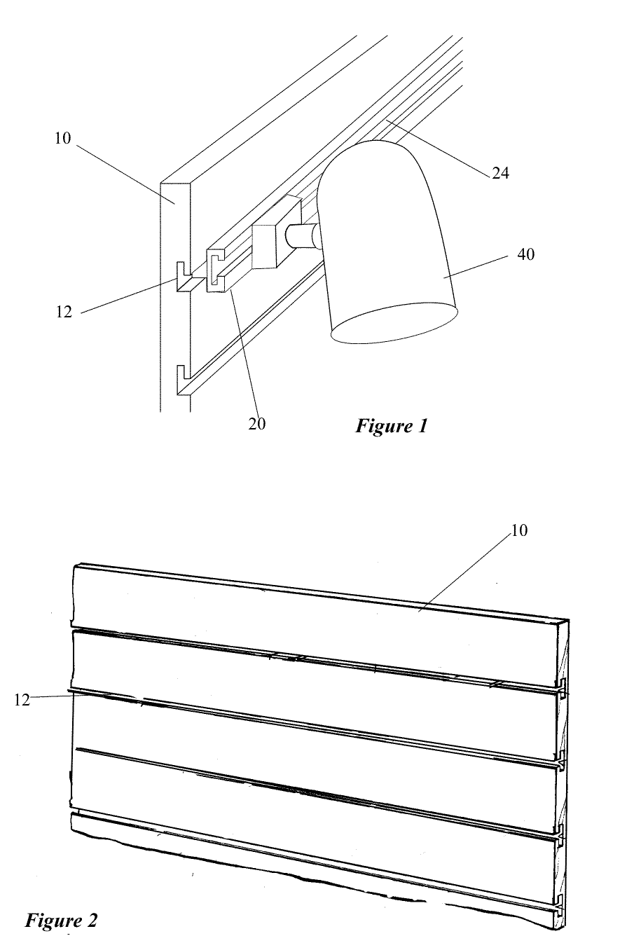

A preferred embodiment of the present invention is illustrated in FIGS. 1-5. This embodiment uses a commercially available product commonly referred to as slatwall. Slatwall is often found in merchandising retail displays but is becoming commonly used in homes, workshops and office environments. A typical slatwall 10 is illustrated in FIGS. 1-4. The slatwall 10 includes a plurality of parallel slots 12 that are normally spaced two to six inches apart, although any spacing may be used. The slatwall is typically formed from wood or extruded plastic although any structural material may be used. The slots 12 are typically about one quarter to three quarter inches wide and up to one half inch thick. The slots 12 may be either a T shaped slot or an L shaped slot or any other suitable shape. It is to be understood that any size slot, spacing or material may be used under the present invention. The slatwall may be purchased in preconfigured sizes or assembled in a modular form.

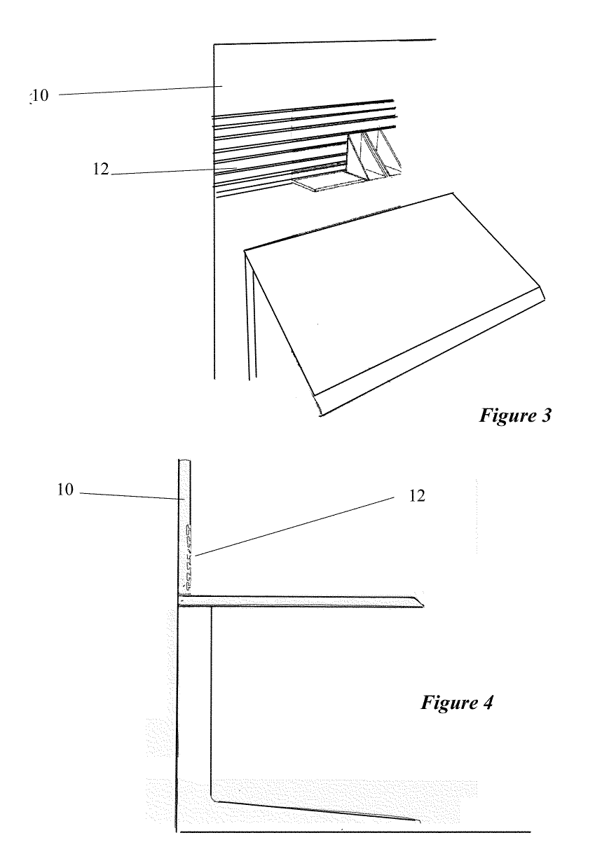

The slatwall 10 has uses ranging from displaying merchandise in retail operations, to supporting office accessory items as shown in FIGS. 3 and 4, to organizing tools and other shop items in workshops to any number of other applications. The support shelves or other items that are used with the slatwalls typically have an inverted L shaped or T shaped bracket that engages in the slots 12 of the slatwall 10.

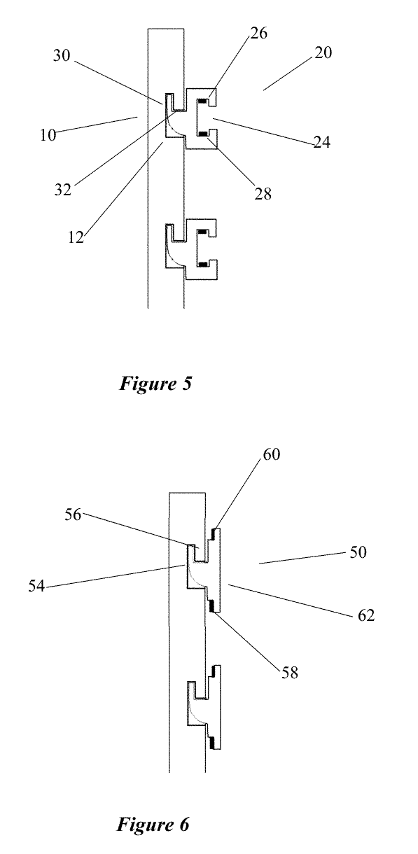

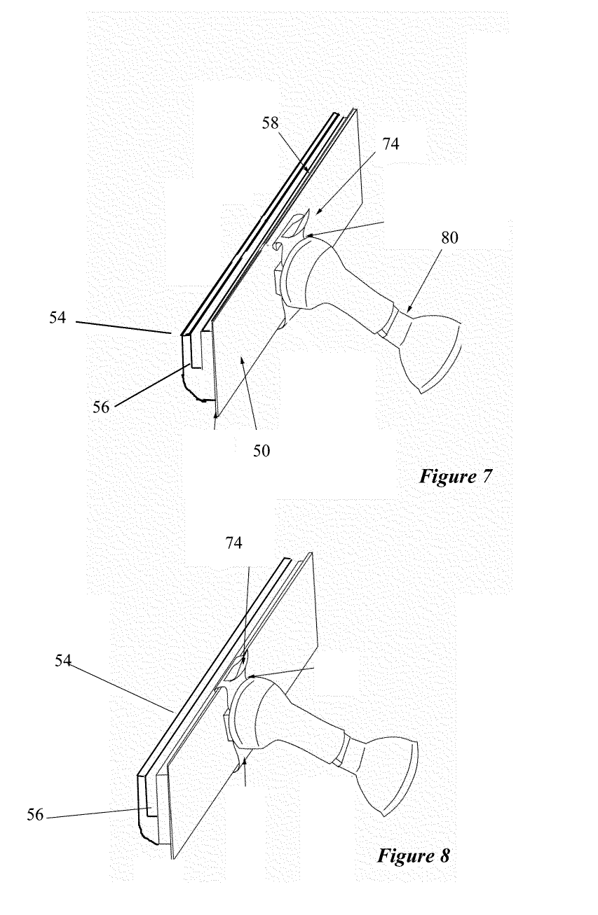

A preferred embodiment of the present invention provides a lighting system that has particular utility for use with a slatwall system or other systems that utilize engagement slots. It is to be expressly understood that while slatwalls are discussed herein, this term for purposes of this application encompass all types of room surfaces that have one or more slots, grooves or engagement apertures. Referring in more detail to the drawings, as shown in FIGS. 1 and 5, a preferred embodiment of the present invention is described.

Lighting adapter 20, as shown in FIGS. 1 and 5, includes an elongated track 22 formed from extruded plastic, aluminum, sheet metal or any other suitable material. A T shaped slot 24 is formed in the track 22. Electrical connection strips 26, 28 are attached in opposing sides of the T shaped slot 24 as shown in FIG. 5. These strips 26, 28 are connected to a power supply (not shown) that can supply either AC voltage or low DC voltage. Typically a transformer converts standard 110 volt AC power to either low voltage AC or low voltage DC power that is then supplied to the strips 26, 28.

Engagement tongue element 30 extends upwardly from the rear side of the slatwall adapter 20. Slot 32 spaces the tongue element 30 from the backside of the adaptor and includes a width approximately the width of the overhanging slot 12 of the slatwall. The tongue element 30 is preferably resilient and deformable in order to be inserted into the slot 12. The interference between the tongue element 30, the slot 32 and the overhanging sides of the slot 12 provide a secure engagement between the adapter 20 and the slatwall 10.

Light fixture 40 is a typical track light fixture and is commercially available in this embodiment of the present invention. The light fixture 40 includes electrical contact members that engage against electrical connection strips 26, 28 within the slot 24 of the adapter 20. The light fixture 40 also includes a conventional connection mechanism (not shown) to secure the fixture from accidental dislodgement from the adapter 20.

In use, the adapter 20 is secured to the slatwall 10 by inserting the tongue element 30 into a slot 12 on the slatwall. The interference between the tongue element 30 and the inside of the slot 12, as shown in FIG. 5, secures the adapter 20 to the slatwall. The adaptor 12 can be easily removed as well by simply pulling it away from the slot and slatwall. Also, the adaptor 12 can be slid laterally within the slot to a desired position. The power supply is attached to the electrical connection strips 26, 28. The light fixtures 40 can then be secured in the track slot 24 and secured so that the fixture electrical contact members engage against the electrical connection strips 26, 28. The light fixture 40 can be placed anywhere along the length of the adapter 20.

The combination of the track light rail adapter 20 and the slatwall allow light to be easily and quickly applied in an office, workshop, retail display or other use where a slatwall may be utilized. The lighting can be quickly moved to a plurality of locations and heights while the track adapter allows the light fixtures to be easily positioned as desired.

It is to be expressly understood that the above descriptive embodiment is intended for explanatory purposes only and is not meant to limit the scope of the invention. Other embodiments are certainly within the scope of the claimed invention. For example, the adapter 20 could omit the internal slot completely and provide a mounting surface instead that would allow a track or rail for track lighting to be mounted directly on the mounting surface instead.

Another embodiment of the present invention is shown in FIGS. 6 and 8. This embodiment utilizes a low profile track such as the electrical track lighting system disclosed in U.S. Pat. No. 6,540,372 and U.S. patent application publication 20040033708 of Ser. No. 10,378,460, both assigned to the present assignee and incorporated herein by reference. The adaptor 50 of this embodiment includes a low profile rail 52. The adaptor 50 also includes a tongue 54 and slot 56 similar to the above described tongue and slot to allow engagement in a slot 12 of a slatwall system. The rail 52 includes an outer exposed surface 62 with electrical contact surfaces 58, 60 on opposing sides of the rail 52 on the rear surface of the rail 52. In this embodiment the rail may be removably attachable to the track. The outer exposed surface 62 of track 52 is a substantially flat planar surface. As discussed in further detail below, the smooth flat bottom surface 14 can have decorative tape mounted to it, or even painted as desired. The ability to paint the smooth flat bottom surface 62 of the track 52 as well as the low profile of the track allows it to be easily hidden from sight or else used as an accent for the room.

Electrical contact rails 58, 60 are mounted or formed on the rear side of track 52. These contact rails are mounted to the track 52 snapping or pressing into a formed slot. The contact rails may also be mounted to the track by a thin adhesive layer or even formed as an adhesive sided tape. The contact rails are formed of conductive materials, such as copper, brass, aluminum or other known conductive materials. The contact rails are parallel and spaced from one another as well. The rails are electrically insulated from one another through the insulation properties of the track 52. The contact rails 58, 60, in the preferred embodiment, are flat copper, but could also be round, square or other shapes and sizes of exposed electrical wire as well. The contact rails extend the full length of the track 12.

Electrical current is supplied to the contact rails 58, 60 of the track 52 in one preferred embodiment by a power strip. A preferred embodiment of the low profile power strip is connected between a transformer and the track 52. The power strip carries flattened electrical leads and is low profile with upper radiused corners. The bottom surface of the power strip is hollow and includes an adhesive backing tape. These features provide a low profile, unobtrusive power strip that can be painted to match the wall, ceiling or other mounting surface. However, any type of electrical conductor may be used.

In the preferred embodiment, an electrical power transformer and switch is plugged into an AC electrical outlet or wired directly into the household AC current. The AC current is transformed by electrical transformer in the power supply/switch into low voltage current. This current is then applied to the contact rails 58, 60, in opposing polarity. The switch may also include a dimmer switch to adjust the brightness of the light fixtures as well as turn the fixtures on and off.

An example of the light fixture 70 includes a base member formed of a high strength resilient plastic material. A clip 74 is formed on one side of the base member. A bendable tube 72 formed of a braided metal material, plastic, or other bendable material extends from the base member to a lamp holder. A lamp socket 80 having elongated wires extend through the bendable tube for engagement with contacts that then engage with the contact rails of the track 52. Assembly wires may also be used to provide structural integrity for the tube to hold the lamp fixture together. In use, the user simply engages one side of the base member over the track 12 and snaps the other side over the other side of the track. The clip may be used to ensure engagement or to release the lamp fixture from the track 52.

In this preferred embodiment, the base member of the light fixture is formed of a molded resilient flexible plastic material. This material provides a spring pressure to push the spring clips against the contact surfaces by applying pressure on the opposite of the base member. It is also to be understood that the base member could be a stiff, rigid material and the spring clips themselves provide the resilient force.

It is to be expressly understood that other types of light fixtures, tracks and rails may be used within the scope of the present invention. The above embodiments are intended for descriptive purposes only.

As will be understood by those familiar with the art, the present invention may be embodied in other specific forms without departing from the spirit or essential characteristics thereof. For example, the present invention is not limited in the configuration of the tracks or rails, or the light fixtures that may be used in the present invention.

1. A lighting system, said lighting system comprising:
an elongated track;
said elongated track having at least one engagement element for attachment to an aperture formed in a room surface;
at least one conductor running laterally along the length of said elongated track;
a power supply for supplying electrical power to each of said at least one conductor;
at least one lighting fixture
an attachment member on each of said at least one light fixture for engagement with said elongated track; and a conductive element on each of said at least one light fixtures for engagement with each one of said at least one conductors on said elongated track for supplying electrical power to said lighting fixture.

2. The system of claim 1 wherein said at least one engagement element is engageable in a slot on a slatwall to secure said elongated track to a slatwall.

3. The system of claim 1 wherein said elongated track includes:
an internal channel; and
said at least one conductor is mounted in said internal channel.

4. The system of claim 1 wherein said elongated track includes:
an internal channel; and
said at least one conductor includes two conductors mounted on opposing sides of said internal channel.

5. The system of claim 1 wherein said elongated track includes:
a substantially flat outer surface; and
said at least one conductor is mounted on the rear side of said elongated track opposite of said substantially flat outer surface.

6. The system of claim 1 wherein said elongated track includes:
a substantially flat outer surface; and
said at least one conductor includes two conductors mounted on the rear side of said elongated track opposite of said substantially flat outer surface.

7. The system of claim 1 wherein said elongated track includes:
a substantially flat outer surface;
a rail mountable onto said outer surface; and
said at least one conductor is mounted on said rail.

8. The system of claim 1 wherein said aperture is formed from a continuous slot on a room surface, and said engagement element includes an interference allowing said engagement element to fasten securely within said continuous slot.

9. A lighting system for a slatwall, said lighting system comprising:
a slatwall surface having one or more slots;
an elongated track;
said elongated track having at least one engagement element for attachment to a slot on said slatwall surface;
at least one conductor running laterally along the length of said elongated track;
a power supply for supplying electrical power to each of said at least one conductor;
at least one lighting fixture
an attachment member on each of said at least one light fixture for engagement with said elongated track; and
a conductive element on each of said at least one light fixtures for engagement with each one of said at least one conductors on said elongated track for supplying electrical power to said lighting fixture.

10. The system of claim 9 wherein said at least one engagement element is engageable in a slot on a slatwall to secure said elongated track to a slatwall.

11. The system of claim 9 wherein said elongated track includes:
an internal channel; and
said at least one conductor is mounted in said internal channel.

12. The system of claim 9 wherein said elongated track includes:
an internal channel; and
said at least one conductor includes two conductors mounted on opposing sides of said internal channel.

13. The system of claim 9 wherein said elongated track includes:
a substantially flat outer surface; and
said at least one conductor is mounted on the rear side of said elongated track opposite of said substantially flat outer surface.

14. The system of claim 9 wherein said elongated track includes:
a substantially flat outer surface; and
said at least one conductor includes two conductors mounted on the rear side of said elongated track opposite of said substantially flat outer surface.

15. The system of claim 9 wherein said elongated track includes:
a substantially flat outer surface;
a rail mountable onto said outer surface; and
said at least one conductor is mounted on said rail.

16. The system of claim 9 wherein said one or more slots are horizontal.

17. The system of claim 9 wherein said one or more slots are vertical.

18. The system of claim 9 wherein said one or more slots are curved.

19. A method for installing lighting fixtures comprised of:
selecting a room surface with one or more slots;
attaching a substantially elongated track onto said room surface by engaging an engagement element formed on said elongated track with one of said slots;
providing power to a set of conductors attached to said elongated track; and
attaching a lighting fixture onto said elongated track.

20. The method of claim 19 wherein said method further comprises:
removing and relocating said lighting fixture to another location on said elongated track.

21. The method of claim 19 wherein said method further comprises:
relocating said lighting fixture to another location by sliding said lighting fixture while attached to said elongated track.
